(19) United States
(12) Patent Application Publication
(10) Pub. No.: US 2011/0015895 A1
(43) Pub. Date: Jan. 20, 2011

(54) MAGNETIC DATA PROCESSING DEVICE, MAGNETIC DATA PROCESSING METHOD, AND MAGNETIC DATA PROCESSING PROGRAM

(75) Inventor: Ibuki Handa, Hamamatsu-shi (JP)

Correspondence Address: Dickstein Shapiro LLP, 2049 Century Park East, Suite 700, Los Angeles, CA, 90067, US

(73) Assignee: Yamaha Corporation, Hamamatsu-Shi (JP)

(21) Appl. No.: 12/831,181

(22) Filed: Jul. 6, 2010

(30) Foreign Application Priority Data
Jul. 17, 2009 (JP) 2009-168977

(51) Int. Cl. G06F 17/18

(52) U.S. Cl. 702/179

(57) ABSTRACT

In a magnetic data processing device, an accumulating part repeatedly accumulates a predetermined number of magnetic data q₁, . . . , q_{N} (N≧4) to provide a statistical population, the predetermined number being four or greater, while sequentially acquiring magnetic data output from a three-dimensional (3D) magnetic sensor. A determination part derives, each time a statistical population is provided, a minimum value of f(p) as a reliability index S of the statistical population, and determines whether or not the statistical population is sufficiently reliable using the reliability index S. An offset derivation part derives an offset of the magnetic data based on the statistical population in case that the statistical population is sufficiently reliable, wherein f(p) is defined by the following equation:

f(p)=(Xp−j)^{T}(Xp−j)

### BACKGROUND OF THE INVENTION

1. Technical Field of the Invention

The present invention relates to a magnetic data processing device, a magnetic data processing method, and a magnetic data processing program, and more particularly to offset correction of three-dimensional Earth magnetic data.

2. Description of the Related Art

A conventional three-dimensional (3D) Earth magnetic sensor is mounted on a movable body such as a mobile phone to detect the direction of the Earth's magnetic field. When a magnetic data processing device derives orientation based on magnetic data, the device needs to perform a process for correcting the magnetic data to eliminate measurement errors caused by magnetization of the movable body. A control value used for this correction process is derived based on a plurality of magnetic data and is referred to as an “offset” (see the following Patent References 1, 2, and 3).

[Patent Reference 1] Japanese Patent Application Publication No. 2007-240270

[Patent Reference 2] Japanese Patent Application Publication No. 2007-107921

[Patent Reference 3] Japanese Patent Application Publication No. 2007-139715

However, the magnetic data includes not only offset components caused by magnetization of the movable body but also error components caused by magnetic fields generated by electronic circuits mounted in the movable body or caused by fluctuations of outputs of the magnetic sensor according to Gaussian distribution. Accordingly, to correctly derive a true offset caused by magnetization of the movable body, there is a need to store a plurality of magnetic data that are spread three-dimensionally over a wide range. However, since special movement is required for the movable body to store such magnetic data, it is generally necessary for the user to perform an operation causing the movable body to make such a special movement. Since the true offset varies irregularly, orientation derived by the magnetic data processing device is likely to differ from the actual orientation unless the user frequently performs such an operation.

The present inventor has previously created an invention capable of deriving an offset close to the true offset without requiring the user to perform such a special operation (see Patent Reference 1). Patent Reference 1 describes a method in which an offset is derived three-dimensionally based on a statistical population of magnetic data when the distribution of the magnetic data of the statistical population is three-dimensional and an offset is derived two-dimensionally based on a statistical population of magnetic data when the distribution of the magnetic data of the statistical population is two-dimensional. In the case where the magnetic data of the statistical population is not spread three-dimensionally, this method two-dimensionally corrects, if the magnetic data of the statistical population is spread two-dimensionally, an offset derived in the past for a direction parallel to a plane in which the magnetic data is spread two-dimensionally.

Patent References 1, 2, and 3 all determine whether or not the statistical population is sufficiently reliable for deriving the offset. In the methods described in Patent References 1, 2, and 3, a function of the average r of distances between all magnetic data of the statistical population and a candidate offset derived based on the statistical population is used as an index used for the reliability determination. However, according to the method described in Patent Reference 1, the position of the candidate offset obtained by two-dimensionally correcting the offset derived in the past depends on the position of the offset derived in the past. Accordingly, even when candidate offsets are derived from the same statistical population, the respective averages r of the distances between all magnetic data of the statistical population and the candidate offsets derived based on the same statistical population are different if the positions of the offsets derived in the past are different. As a result, indices indicating whether or not the statistical population is sufficiently reliable for deriving the offset are different even though candidate offsets corresponding to the indices are derived from the same statistical population. In addition, in the methods described in Patent References 1, 2, and 3, since there is a need to derive the candidate offset to determine whether or not the statistical population is sufficiently reliable for deriving the offset, deriving the candidate offset is useless if the derived candidate offset is discarded, because derived candidate offset is never used actually.

### SUMMARY OF THE INVENTION

Therefore, it is an object of the present invention to reduce the amount of calculation used to determine reliability of a statistical population used to derive an offset of magnetic data while giving consistency to the reliability determination.

(1) A magnetic data processing device for achieving the above object comprises: an accumulating part that repeatedly accumulates a predetermined number of magnetic data q₁, . . . , q_{N} (N≧4) to provide a statistical population, the predetermined number being four or greater, while sequentially acquiring magnetic data output from a three-dimensional (3D) magnetic sensor; a determination part that derives, each time a statistical population is provided, a minimum value of f(p) as a reliability index S of the statistical population, and that determines whether or not the statistical population is sufficiently reliable using the reliability index S; and an offset derivation part that derives an offset of the magnetic data based on the statistical population in case that the statistical population is sufficiently reliable,

wherein f(p) is defined by the following equation:

$$\begin{matrix}f ( p ) = {( Xp - j )}^{T} ( Xp - j ) \\ where \\ X = [ \begin{matrix}{( {q}_{1} - \overline{q} )}^{T} \\ {( {q}_{2} - \overline{q} )}^{T} \\ {( {q}_{3} - \overline{q} )}^{T} \\ … \\ {( {q}_{N} - \overline{q} )}^{T}\end{matrix} ] \\ j = \frac{1}{2} [ \begin{matrix}{q}_{1}^{T} {q}_{1} - R \\ {q}_{2}^{T} {q}_{2} - R \\ {q}_{3}^{T} {q}_{3} - R \\ … \\ {q}_{N}^{T} {q}_{N} - R\end{matrix} ] \\ \overline{q} = \frac{1}{N} {\sum }_{i = 1}^{N} {q}_{i} \\ R = \frac{1}{N} {\sum }_{i = 1}^{N} {q}_{i}^{T} {q}_{i}\end{matrix}$$

The minimum value of the function f(p) increases as variation of the statistical population from a spherical surface about which the statistical population is concentrated increases. Accordingly, it is possible to determine the reliability of the statistical population using the minimum value of the function f(p) as a reliability index S. In addition, the determination of reliability of the statistical population is consistent since the reliability of the statistical population is determined using the minimum value of the function f(p) which uses, as constants, X and j determined by the statistical population regardless of the offset derived in the past. Further, according to the invention, it is possible to reduce the amount of calculation used to determine the reliability of the statistical population since the reliability of the statistical population can be determined without deriving the candidate offset.

(2) In the magnetic data processing device for achieving the above object, when eigenvalues of a symmetric matrix A are denoted by λ₁, λ₂, and λ₃ (λ₁≧λ₂≧λ₃) eigenvectors of magnitude 1 corresponding respectively to the eigenvalues λ₁, λ₂, and λ₃ are denoted by u₁, u₂, and u₃, and a predetermined threshold is denoted by α, the determination part may derive the reliability index S as the following equation:

$$S = \{ \begin{matrix}c - ( \frac{{b}_{1}^{′2}}{{λ}_{1}} + \frac{{b}_{2}^{′2}}{{λ}_{2}} + \frac{{b}_{3}^{′2}}{{λ}_{3}} ) … {λ}_{3} > α \\ c - ( \frac{{b}_{1}^{′2}}{{λ}_{1}} + \frac{{b}_{2}^{′2}}{{λ}_{2}} ) … otherwise\end{matrix} \\ where \\ A = {X}^{T} X \\ b = {X}^{T} j , c = {j}^{T} j \\ {b}^{′} = {L}^{T} b \\ {b}^{′} = ( {b}_{1}^{′} , {b}_{2}^{′} , {b}_{3}^{′} ) \\ L = [ \begin{matrix}{u}_{1} & {u}_{2} & {u}_{3}\end{matrix} ] .$$

(3) In the magnetic data processing device for achieving the above object, the determination part may determine whether or not the statistical population is spread three-dimensionally using a threshold, and the offset derivation part may derive, as the offset, a value p which minimizes f(p) in case that the statistical population is spread three-dimensionally.

According to the invention, it is possible to reduce the amount of calculation used to derive the offset since coefficients included in the function used to determine the reliability of the statistical population are equal to coefficients of the simultaneous equations used to derive the offset.

(4) In the magnetic data processing device for achieving the above object, the determination part may determine whether or not the statistical population is spread two-dimensionally using a threshold, and in case that the statistical population is spread two-dimensionally, the offset derivation part may derive, as the offset, a value p which minimizes f(p) under a constraint condition of p=p₀+β₁u₁+β₂u₂ (β₁, β₂: real numbers) where eigenvalues of a symmetric matrix A=X^{T}X are denoted by λ₁, λ₂, and λ₃ (λ₁≧λ₂≧λ₃), eigenvectors of magnitude 1 corresponding respectively to the eigenvalues λ₁, λ₂, and λ₃ are denoted by u₁, u₂, and u₃, and a previously derived offset is denoted by p₀.

According to the invention, it is possible to reduce the amount of calculation used to derive the offset since coefficients included in the function used to determine the reliability of the statistical population are equal to coefficients of the simultaneous equations used to derive the offset. In addition, even when the statistical population is not spread three-dimensionally, it is possible to derive an offset closer to the true offset if the statistical population is spread two-dimensionally.

The functions of each part described in the claims are implemented by any of hardware resources whose functions are specified by the configuration itself, hardware resources whose functions are specified by a program, or a combination thereof. The functions of each part are not limited to those implemented by physically independent hardware resources. The invention may also be applied to a magnetic data processing method, a magnetic data processing program, and a machine readable storage medium containing the magnetic data processing program. Of course, the storage medium containing the magnetic data processing program may be a magnetic recording medium or a magneto-optical recording medium and may be any other recording medium developed in the future.

### BRIEF DESCRIPTION OF THE DRAWINGS

FIG. 1 is a block diagram of an embodiment of the invention.

FIG. 2 is a flow chart of the embodiment of the invention.

FIG. 3 is a schematic diagram of the embodiment of the invention.

### DETAILED DESCRIPTION OF THE INVENTION

Embodiments of the invention will now be described with reference to the accompanying drawings. Corresponding elements in each figure will be denoted by like reference numerals and a redundant description thereof will be omitted.

### 1. First Embodiment

(Overview)

In the first embodiment of the invention, an offset is derived three-dimensionally based on a statistical population when a distribution of magnetic data of the statistical population is three-dimensional. On the other hand, when the distribution of magnetic data of the statistical population is two-dimensional, an offset is derived by correcting an offset derived in the past (i.e., old offset) two-dimensionally based on the statistical population. In addition, a process for deriving the offset using the statistical population is not performed when magnetic data of the statistical population has a variance from a sphere (i.e., a spherical surface) about which the magnetic data of the statistical population is concentrated.

(Configuration of Magnetic Data Processing Device)

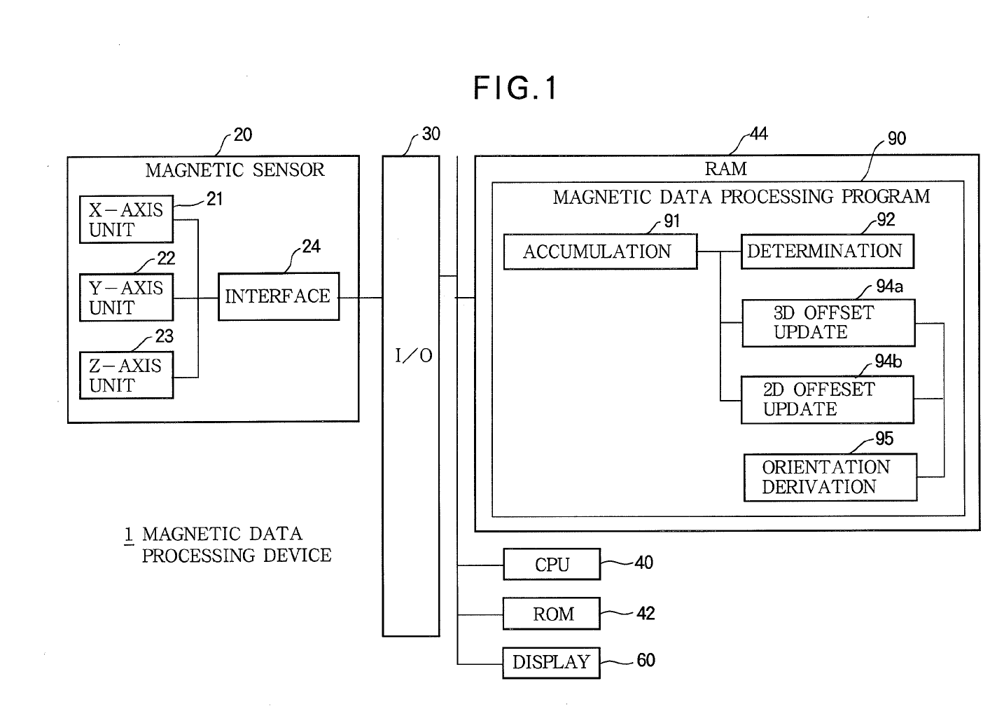

FIG. 1 is a block diagram illustrating an embodiment of a magnetic data processing device of the invention. The magnetic data processing device 1 is mounted on a portable information terminal such as a mobile phone, a Personal Navigation Device (PND), an electronic compass, or a digital camera.

The magnetic data processing device 1 includes a magnetic sensor 20 and a microcomputer. The microcomputer includes a CPU 40, a ROM 42, a RAM 44, an input/output unit (I/O) 30, and the like. The magnetic data processing device 1 receives magnetic data output from the magnetic sensor 20 and outputs orientation data to visually or audibly inform the user of a travel direction or an expected travel route based on offset-corrected magnetic data. A display unit 60 includes a display panel and a display driver for displaying an image indicating the orientation.

The magnetic sensor 20 is a 3D magnetic sensor including an x-axis sensor 21, a y-axis sensor 22, and a z-axis sensor 23, which detect three orthogonal axis components of a magnetic field vector, and an interface 24. The x-axis sensor 21, the y-axis sensor 22, and the z-axis sensor 23 each include a magnetic resistance element, a hall element, or the like and may each be any type of linear 1D magnetic sensor. The x-axis sensor 21, the y-axis sensor 22, and the z-axis sensor 23 are fixed such that sensing directions thereof are orthogonal to each other. The interface 24 receives outputs of the x-axis sensor 21, the y-axis sensor 22, and the z-axis sensor 23 through time division and performs amplification and AD conversion on the received outputs of the three sensors 21, 22, and 23 to output magnetic data q=(qₓ, q_{y}, q_{z}). The magnetic data q, which is a digital signal output from the interface 24, is stored in the RAM 44 at a specific address. The ROM 42, which is a nonvolatile machine readable storage medium, stores a magnetic data processing program 90, which is loaded into the RAM 44 and executed by the CPU 40, and a variety of programs for implementing functions of the portable information terminal.

The magnetic data processing program 90 is a program for outputting orientation data based on magnetic data and is stored in the ROM 42. The orientation data is vector data indicating the direction of the Earth's magnetic field. The magnetic data processing program 90 includes a group of modules such as an accumulating module 91, a determination module 92, a 3D offset update module 94a, a 2D offset update module 94b, and an orientation derivation module 95.

The accumulating module 91 is a program module that implements a function to repeatedly store N magnetic data q₁, . . . , q_{N} (N≧4) as a statistical population while sequentially acquiring magnetic data output from the 3D magnetic sensor. That is, the accumulating module 91 implements a function to sequentially acquire magnetic data output from the magnetic sensor 20 at regular time intervals and to accumulate the acquired magnetic data in a buffer. The buffer is a storage region in the RAM 44 for storing N magnetic data.

The determination module 92 is a program module that implements a function to determine, each time a statistical population is stored, the reliability of the statistical population and to determine whether or not the statistical population is spread two-dimensionally.

In this embodiment, when eigenvalues of a symmetric matrix A corresponding to principal values of the distribution of a statistical population q₁, . . . , q_{N} are denoted by “λ₁”, “λ₂”, and “λ₃” (λ₁≧λ₂≧λ₃), eigenvectors corresponding respectively to the eigenvalues “λ₁”, “λ₂”, and “λ₃” are denoted by “u₁”, “u₂”, and “u₃”, and a predetermined threshold is denoted by “α₁”, the determination module 92 uses “S” defined by the following equations (1) as a reliability index representing the reliability of the statistical population and determines that the statistical population is sufficiently reliable when the reliability index S and a predetermined threshold α₂ satisfy a condition that S>α₂.

$$\begin{matrix}S = \{ \begin{matrix}c - ( \frac{{b}_{1}^{′2}}{{λ}_{1}} + \frac{{b}_{2}^{′2}}{{λ}_{2}} + \frac{{b}_{3}^{′2}}{{λ}_{3}} ) … {λ}_{3} > {α}_{1} \\ c - ( \frac{{b}_{1}^{′2}}{{λ}_{1}} + \frac{{b}_{2}^{′2}}{{λ}_{2}} ) … otherwise\end{matrix} \\ where & ( 1 ) \\ \overline{q} = \frac{1}{N} {\sum }_{i = 1}^{N} {q}_{i} & ( 2 ) \\ X = [ \begin{matrix}{( {q}_{1} - \overline{q} )}^{T} \\ {( {q}_{2} - \overline{q} )}^{T} \\ {( {q}_{3} - \overline{q} )}^{T} \\ … \\ {( {q}_{N} - \overline{q} )}^{T}\end{matrix} ] & ( 3 ) \\ A = {X}^{T} X & ( 4 ) \\ R = \frac{1}{N} {\sum }_{i = 1}^{N} {q}_{i}^{T} {q}_{i} & ( 5 ) \\ j = \frac{1}{2} [ \begin{matrix}{q}_{1}^{T} {q}_{1} - R \\ {q}_{2}^{T} {q}_{2} - R \\ {q}_{3}^{T} {q}_{3} - R \\ … \\ {q}_{N}^{T} {q}_{N} - R\end{matrix} ] & ( 6 ) \\ b = {X}^{T} j , c = {j}^{T} j & ( 7 ) \\ {b}^{′} = {L}^{T} b & ( 8 ) \\ {b}^{′} = ( {b}_{1}^{′} , {b}_{2}^{′} , {b}_{3}^{′} ) & ( 9 ) \\ L = [ \begin{matrix}{u}_{1} & {u}_{2} & {u}_{3}\end{matrix} ] . & ( 10 )\end{matrix}$$

The symmetric matrix A corresponds to N times a variance-covariance matrix since the symmetric matrix A is also written as the following equation.

$$A = {\sum }_{i = 1}^{N} ( {q}_{i} - \overline{q} ) {( {q}_{i} - \overline{q} )}^{T}$$

The following is the reason why the reliability index S represents the extent of variation of the statistical population from a sphere (i.e., a spherical surface) about which the statistical population is concentrated.

When the statistical population includes four magnetic data elements q₁, . . . , q₄ that are not in the same line, a spherical surface including the statistical population is uniquely specified without using a statistical method. A position vector p=(pₓ, p_{y}, p_{z}) of the center of the spherical surface and the four magnetic data elements q₁, . . . , q₄ satisfy the following equation (11). Accordingly, the center of the spherical surface can be obtained by solving simultaneous equations (12), into which Equation (11) is modified. Although the number of equality constraints is four for three variables, the equations (12) must have a solution since one of the 4 equality constraints is redundant.

$$\begin{matrix}{‖ {q}_{i} - p ‖}_{2}^{2} = {r}^{2} & ( 11 ) \\ [ \begin{matrix}{( {q}_{1} - \overline{q} )}^{T} \\ {( {q}_{2} - \overline{q} )}^{T} \\ {( {q}_{3} - \overline{q} )}^{T} \\ {( {q}_{4} - \overline{q} )}^{T}\end{matrix} ] p = \frac{1}{2} [ \begin{matrix}{q}_{1}^{T} {q}_{1} - R \\ {q}_{2}^{T} {q}_{2} - R \\ {q}_{3}^{T} {q}_{3} - R \\ {q}_{4}^{T} {q}_{4} - R\end{matrix} ] & ( 12 ) \\ where & \\ R = \frac{1}{N} {\sum }_{i = 1}^{4} {q}_{i}^{T} {q}_{i} & ( 13 )\end{matrix}$$

Here, if simultaneous linear equations (14) for “p” have a solution when the number of data elements of the statistical population is five or more, the solution p=(pₓ, p_{y}, p_{z}) is the center of the spherical surface including the data set of the statistical population.

Xp=j (14)

However, the equation (14) rarely has a solution when measurement errors of the magnetic sensor 20 are taken into consideration. Thus, let us introduce a vector “e” defined as in the following equation (15) in order to obtain a feasible solution using a statistical method.

e=Xp−j (15)

The value of “p” which minimizes ∥e∥₂² (i.e., e^{T}e) can be considered the center of a spherical surface with the smallest distance to the statistical population, i.e., the center of a spherical surface about which the statistical population is distributed. When the matrix A is regular, the problem of obtaining the value of “p” which minimizes ∥e∥₂² is an optimization problem of minimizing an objective function of the following Equation (16).

f(p)=(Xp−j)^{T}(Xp−j) (16)

The objective function f(p) increases as the variation of the statistical population from a specific spherical surface about which the statistical population is concentrated increases, and is zero when all magnetic data of the statistical population are included in the spherical surface. Accordingly, the minimum value of f(p) indicates the extent of variation of the statistical population from the spherical surface about which the statistical population is concentrated. That is, the minimum value of f(p) can be used as a reliability index S of the statistical population. Here, when b and c are defined as in Equation (7), Equation (16) can be expressed in quadratic form as in the following Equation (17).

f(p)=p^{T}Ap−2b^{T}p+c (17)

Even when the symmetric matrix includes an eigenvalue of

Even when the symmetric matrix includes an eigenvalue of 0, the objective function f(p) must have a minimum value when the matrix A is defined as in Equation (4) and b is defined as in Equation (7). Here, when eigenvectors of magnitude 1 corresponding respectively to the eigenvalues λ₁, λ₂, and λ₃ (λ₁≧λ₂≧λ₃) of the symmetric matrix are denoted by u₁, u₂, and u₃ and L is defined by Equation (10), the symmetric matrix can be diagonalized as in Equation (18).

$${L}^{T} A L = [ \begin{matrix}{λ}_{1} & 0 & 0 \\ 0 & {λ}_{2} & 0 \\ 0 & 0 & {λ}_{3}\end{matrix} ] \qquad ( 18 )$$

In addition, when transformation of coordinates of Equation (8) is performed using L for b, the minimum value min of the objective function f(p) is expressed as in Equation (19) if the symmetric matrix is positive definite (i.e., if the symmetric matrix has no eigenvalue of 0).

min=c−b′^{T}(L^{T}AL)⁻¹b′ (19)

When Equation (19) is rewritten by expressing b′ as in Equation (9), the minimum value min of the objective function f(p) is expressed as in the following Equation (20).

$$min = c - ( \frac{{b}_{1}^{′2}}{{λ}_{1}} + \frac{{b}_{2}^{′2}}{{λ}_{2}} + \frac{{b}_{3}^{′2}}{{λ}_{3}} ) \qquad ( 20 )$$

When computer calculation errors are taken into consideration, the condition that the symmetric matrix is positive definite is expressed by the following Equation (21) using a threshold α₁ which is defined as a value very close to 0.

λ₃>α₁ (21)

Now, let us consider the case where the symmetric matrix has a single eigenvalue of 0, i.e., where λ₁≧λ₂>0, λ₃=0. In this case, the third term in parentheses in Equation (20) is 0 although an explanation as to why this is is omitted. When λ₃ is very small and Equation (21) is satisfied, the influence of λ₃ upon the reliability index S is large to a non-negligible extent. Accordingly, it is preferable that the threshold α₁ be set to a minimum value in a range excluding 0 in which no exception processing occurs in association with calculation.

As described above, when the minimum value of the objective function f(p) defined by Equation (16) is used as the reliability index S of the statistical population, the reliability index S is expressed as in Equation (1). That is, the determination module 92 compares the reliability index S with the predetermined threshold α₂ and determines that the statistical population is sufficiently reliable when the reliability index S is greater than the threshold α₂.

In this embodiment, λ₃/λ₁ is defined as an index indicating the extent to which the statistical population is distributed three-dimensionally. Also, λ₂/λ₁ is defined as an index indicating the extent to which the statistical population is distributed two-dimensionally. The determination module 92 determines that the statistical population is distributed three-dimensionally when λ₃/λ₁ is greater than a predetermined threshold. In addition, the determination module 92 determines that the statistical population is distributed two-dimensionally when λ₃/λ₁ is not greater than the predetermined threshold and λ₂/λ₁ is greater than another predetermined threshold.

The 3D offset update module 94a is a program module that implements a function to derive an offset three-dimensionally based on the statistical population. Specifically, the 3D offset update module 94a derives, as the offset, the value of “p” which minimizes the objective function f(p) of Equation (16). The value of “p” which minimizes the objective function f(p) can be written as the following Equation (22) when X^{T}X is regular as assumed in this embodiment.

p=(X^{T}X)⁻¹X^{T}j (22)

The 2D offset update module 94b is a program module that implements a function to derive a latest offset by correcting a past offset (old offset) two-dimensionally based on the statistical population. That is, the 2D offset update module 94b implements a function to derive a latest offset based on both the statistical population stored in the accumulating module 91 and the past offset and to update the past offset with the latest offset. Specifically, the 2D offset update module 94b derives the latest offset in the following manner.

In the case where the statistical population is spread concentrating about a specific plane (i.e., when the distribution of the statistical population is two-dimensional), a new offset is derived by restricting directions in which the old offset is corrected to two orthogonal directions. In the case where the statistical population is distributed concentrating on a specific plane while being spread in a direction perpendicular to the plane, the statistical population in a direction parallel to the plane is sufficiently reliable while the statistical population in the direction perpendicular to the plane is unreliable as a data set used for offset correction. In this case, the old offset is not corrected in the direction perpendicular to the plane, thereby preventing the offset from being updated based on unreliable information.

When the statistical population is concentrated about a specific plane while being spread in a direction perpendicular to the plane, the direction perpendicular to the plane is coincident with the direction of an eigenvector u₃ corresponding to the minimum eigenvalue λ₃ and two orthogonal directions parallel to the plane are coincident with the directions of eigenvectors u₁ and u₂ corresponding respectively to the maximum eigenvalue λ₁ and the intermediate eigenvalue λ₂. Accordingly, in order to derive a new offset p without correcting the old offset p₀ in the direction perpendicular to the plane, a new offset p which minimizes the objective function of Equation (16) is found under a constraint condition expressed by the following equation (23).

p=p₀+β₁u₁+β₂u₂ (β₁, β₂: real numbers) (23)

Equation (23) is equivalent to the following equation (24).

u₃^{T}(p−p₀)=0 (24)

The equation for solving the optimization problem of Equation (16) under the constraint condition of Equation (23) can be modified to its equivalent simultaneous equations using the method of Lagrange multipliers. When a Lagrange undetermined multiplier ρ is introduced and “x” is defined by the following equation (25), simultaneous linear equations (26) of “x” are the same as the above-mentioned simultaneous equations.

$$\begin{matrix}x = [ \begin{matrix}p \\ ρ\end{matrix} ] & ( 25 ) \\ {B}_{4} x = {b}_{4} & ( 26 ) \\ where & \\ {B}_{4} = [ \begin{matrix}A & {u}_{3} \\ {u}_{3}^{T} & 0\end{matrix} ] & ( 27 ) \\ {b}_{4} = [ \begin{matrix}{X}^{T} j \\ {u}_{3}^{T} {p}_{0}\end{matrix} ] . & ( 28 )\end{matrix}$$

The orientation derivation module 95 is a program module that generates orientation data by correcting magnetic data sequentially acquired from the magnetic sensor 20 using the latest offset. Specifically, the orientation derivation module 95 outputs, as the orientation data, vector data obtained by subtracting components of the offset from components of the magnetic data which is vector data.

(Magnetic Data Processing Method)

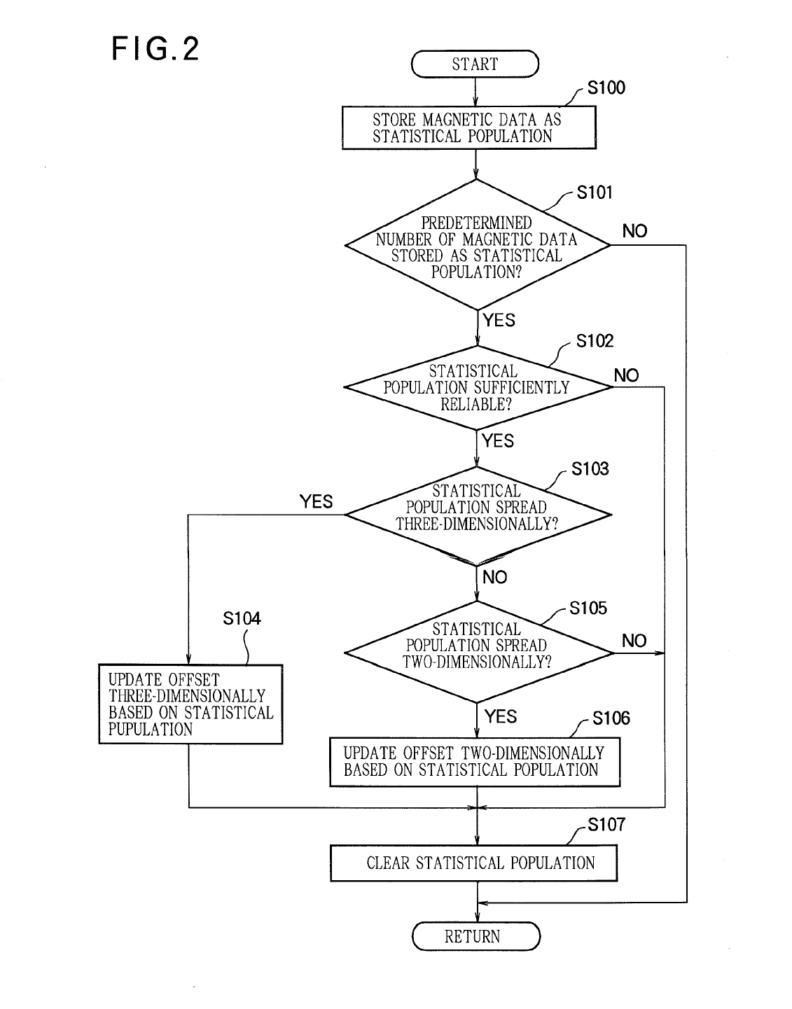

Next, a magnetic data processing method, which is implemented by executing the magnetic data processing program 90, is described with reference to FIG. 2. A procedure of FIG. 2 is repeatedly performed at regular time intervals (for example, at intervals of 10 milliseconds).

First, the accumulating part 91 acquires magnetic data output from the magnetic sensor 20 and stores the acquired magnetic data in the buffer (S100).

Then, the determination module 92 determines whether or not a predetermined number of magnetic data has been stored as a statistical population in the buffer (S101). When the predetermined number of magnetic data has not yet been stored as a statistical population in the buffer, next magnetic data is stored in the buffer after a predetermined time has elapsed (S100).

When the predetermined number of magnetic data has been stored as a statistical population in the buffer, the determination module 92 determines whether or not the statistical population is sufficiently reliable (S102). That is the determination module 92 derives a reliability index S represented by Equation (1) and determines that the statistical population is sufficiently reliable when the reliability index S and the threshold α₂ satisfy s>α₂ and determines that the statistical population is not sufficiently reliable when the reliability index S and the threshold α₂ do not satisfy s>α₂.

When the statistical population is sufficiently reliable, the determination module 92 determines whether or not the statistical population is spread three-dimensionally (S103). That is, the determination module 92 determines that the statistical population is distributed three-dimensionally when λ₃/λ₁ is greater than a predetermined threshold and determines that the statistical population is not distributed three-dimensionally when λ₃/λ₁ is not greater than the predetermined threshold.

When the statistical population is spread three-dimensionally, the offset is updated three-dimensionally based only on the statistical population (S104). That is, the 3D offset update module 94a derives, as a latest offset, the value of “p” represented by Equation (22) using the magnetic data stored in the buffer as a statistical population and updates the past offset with the latest offset.

When the statistical population is not spread three-dimensionally, the determination module 92 determines whether or not the statistical population is spread two-dimensionally (S105). That is, the determination module 92 determines that the statistical population is distributed two-dimensionally when λ₃/λ₁ is not greater than the predetermined threshold and λ₂/λ₁ is greater than another predetermined threshold and determines that the statistical population is not distributed two-dimensionally when λ₃/λ₁ is not greater than the predetermined threshold and λ₂/λ₁ is not greater than another predetermined threshold.

When the statistical population is spread two-dimensionally, the offset is updated by correcting the old offset two-dimensionally based on the statistical population (S106). That is, the 2D offset update module 94b derives the solution “p” of simultaneous linear equations (26) as a latest offset and updates the old offset with the derived latest offset.

When the statistical population is not sufficiently reliable or when the statistical population is spread neither three-dimensionally nor two-dimensionally, the accumulating module 91 discards the statistical population (S107).

In the above procedure, since the reliability of the statistical population can be determined before the latest offset p is derived, the amount of calculation used to determine the reliability of the statistical population is reduced compared to when the reliability of the statistical population is determined after the candidate offset is derived.

Here, let us assume that a function of the average r of the distances between the candidate offset derived based on the statistical population and all magnetic data elements of the statistical population is defined as a reliability index S′ as in the following equation (29).

$${S}^{′} = \frac{1}{N} \frac{1}{{r}^{2}} {\sum }_{i = 1}^{N} {\{ ‖ {q}_{i} - p ‖ - r \}}^{2} \qquad ( 29 )$$

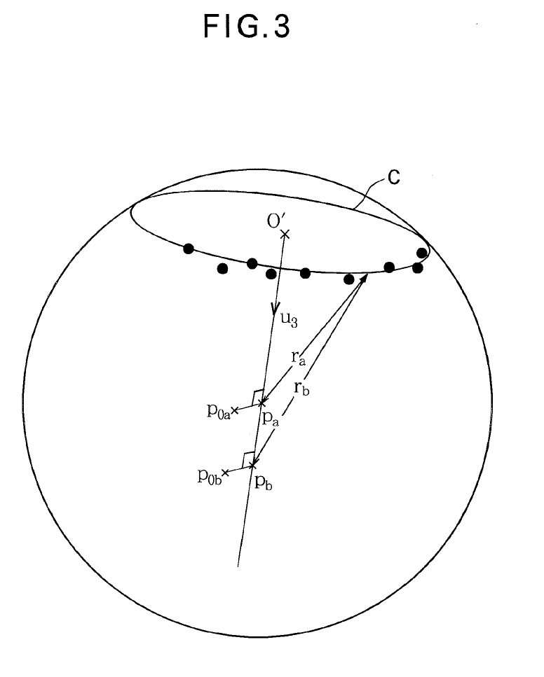

In addition, let us assume that the statistical population is not spread three-dimensionally and is spread two-dimensionally as shown by black dots in FIG. 3 and a candidate offset is derived by correcting the old offset based only on two orthogonal directions as described above. In this case, the candidate offset is pₐ when the old offset is p₀ₐ and the candidate offset is p_{b} when the old offset is p_{0b}. Although both the candidate offsets pₐ and p_{b} are present on a line which passes through a center O′ of a circle C about which the statistical population is concentrated and which is perpendicular to a plane including the circle C, the candidate offsets pₐ and p_{b} do not coincide as long as the two old offsets are not on a surface perpendicular to the line. Accordingly, reliability indices S′ which are functions of the averages rₐ and r_{b} of the distances between the candidate offsets and all magnetic data elements of the statistical population are different according to the positions of the old offsets even though the reliability indices S′ are estimated from the same statistical population. Therefore, when the reliability of the statistical population is determined by comparing the reliability index S′ with a threshold, the threshold should be set taking into consideration a range of obtained distances between the old offset and a plane about which the statistical population is concentrated. When the threshold is set loosely (i.e., set to be low), the statistical population is determined to be reliable if the distance between the old offset and the plane about which the statistical population is concentrated is great even when the statistical population includes significant noise components and is varying. On the other hand, when the threshold is set strictly (i.e., set to be high), the statistical population is determined to be unreliable if the distance between the old offset and the plane about which the statistical population is concentrated is small even when the statistical population does not include significant noise components.

On the other hand, in this embodiment, reliability indices S of statistical populations are always equal if the statistical populations are identical since the reliability of each statistical population is determined using the reliability index S which is a function of only the statistical population as represented in Equation (1). Accordingly, it is possible to strictly set the threshold α₂ which is to be compared with the reliability index S, regardless of variation of the reliability index S′ determined taking into consideration the old offset.

### 2. Other Embodiments

The scope of the invention is not limited to the above embodiments and various modifications can be made without departing from the spirit of the invention.

For example, the part for deriving the offset three-dimensionally based on a statistical population and the part for correcting the old offset two-dimensionally based on a statistical population are not limited to those described in the above embodiments, any known means may be used, and any means that will be developed in the future may also be used. Examples of the known means include a means for deriving an offset two-dimensionally or three-dimensionally using a statistical method, a means for selecting three or four magnetic data from a statistical population and obtaining, from the selected statistical population, the center of a spherical surface as an offset or the center of a circle as a temporary offset for correcting the old offset, etc. The present inventor has previously suggested a plurality of methods for deriving the offset of magnetic data (Japanese Patent Application Publication Nos. 2007-240270, 2007-205944, 2007-139715, 2007-107921, 2007-339478, etc).

For example, the part for determining whether or not the statistical population is spread three-dimensionally or two-dimensionally is not limited to that described in the above embodiments, any known means may be used, and any means that will be developed in the future may also be used. Examples of the known means include a means for comparing the magnitude of variance (or dispersion) of the statistical population with a threshold.

In addition, for example, after an offset is derived based on a statistical population, the reliability of the offset may be determined using another index and another threshold and the derived offset may be discarded when the reliability is low.

What is claimed is:

1. A magnetic data processing device comprising:
an accumulating part that repeatedly accumulates a predetermined number of magnetic data q₁, . . . , q_{N} (N≧4) to provide a statistical population, the predetermined number being four or greater, while sequentially acquiring magnetic data output from a three-dimensional (3D) magnetic sensor;
a determination part that derives, each time a statistical population is provided, a minimum value of f(p) as a reliability index S of the statistical population, and that determines whether or not the statistical population is sufficiently reliable using the reliability index S; and
an offset derivation part that derives an offset of the magnetic data based on the statistical population in case that the statistical population is sufficiently reliable,
wherein f(p) is defined by the following equation:
$$\begin{matrix}f ( p ) = {( Xp - j )}^{T} ( Xp - j ) \\ where \\ X = [ \begin{matrix}{( {q}_{1} - \overline{q} )}^{T} \\ {( {q}_{2} - \overline{q} )}^{T} \\ {( {q}_{3} - \overline{q} )}^{T} \\ … \\ {( {q}_{N} - \overline{q} )}^{T}\end{matrix} ] \\ j = \frac{1}{2} [ \begin{matrix}{q}_{1}^{T} {q}_{1} - R \\ {q}_{2}^{T} {q}_{2} - R \\ {q}_{3}^{T} {q}_{3} - R \\ … \\ {q}_{N}^{T} {q}_{N} - R\end{matrix} ] \\ \overline{q} = \frac{1}{N} {\sum }_{i = 1}^{N} {q}_{i} \\ R = \frac{1}{N} {\sum }_{i = 1}^{N} {q}_{i}^{T} {q}_{i}\end{matrix}$$

2. The magnetic data processing device according to claim 1, wherein, when eigenvalues of a symmetric matrix A are denoted by λ₁, λ₂, and λ₃ (λ₁≧λ₂≧λ₃), eigenvectors of magnitude 1 corresponding respectively to the eigenvalues λ₁, λ₂, and λ₃ are denoted by u₁, u₂, and u₃, and a predetermined threshold is denoted by α, the determination part derives the reliability index S as the following equation:
$$S = \{ \begin{matrix}c - ( \frac{{b}_{1}^{′2}}{{λ}_{1}} + \frac{{b}_{2}^{′2}}{{λ}_{2}} + \frac{{b}_{3}^{′2}}{{λ}_{3}} ) … {λ}_{3} > α \\ c - ( \frac{{b}_{1}^{′2}}{{λ}_{1}} + \frac{{b}_{2}^{′2}}{{λ}_{2}} ) … otherwise\end{matrix} \\ where \\ A = {X}^{T} X \\ b = {X}^{T} j , c = {j}^{T} j \\ {b}^{′} = {L}^{T} b \\ {b}^{′} = ( {b}_{1}^{′} , {b}_{2}^{′} , {b}_{3}^{′} ) \\ L = [ \begin{matrix}{u}_{1} & {u}_{2} & {u}_{3}\end{matrix} ] .$$

3. The magnetic data processing device according to claim 1, wherein the determination part determines whether or not the statistical population is spread three-dimensionally using a threshold, and wherein
the offset derivation part derives, as the offset, a value p which minimizes f(p) in case that the statistical population is spread three-dimensionally.

4. The magnetic data processing device according to claim 1, wherein the determination part determines whether or not the statistical population is spread two-dimensionally using a threshold, and wherein
in case that the statistical population is spread two-dimensionally, the offset derivation part derives, as the offset, p which minimizes f(p) under a constraint condition of p=p₀+β₁u₁+β₂u₂ (β₁, β₂: real numbers) where eigenvalues of a symmetric matrix A=X^{T}X are denoted by λ₁, λ₂, and λ₃ (λ₁≧λ₂≧λ₃), eigenvectors of magnitude 1 corresponding respectively to the eigenvalues λ₁, λ₂, and λ₃ are denoted by u₁, u₂, and u₃, and a previously derived offset is denoted by p₀.

5. The magnetic data processing device according to claim 1, further comprising the 3D magnetic sensor.

6. A magnetic data processing method comprising:
repeatedly accumulating a predetermined number of magnetic data q₁, . . . , q_{N} (N≧4) to provide a statistical population, the predetermined number being four or greater, while sequentially acquiring magnetic data output from a three-dimensional (3D) magnetic sensor;
deriving, each time a statistical population is provided, a minimum value of f(p) as a reliability index S of the statistical population, and determining whether or not the statistical population is sufficiently reliable using the reliability index S; and
deriving an offset of the magnetic data based on the statistical population in case that the statistical population is sufficiently reliable,
wherein f(p) is defined by the following equation:
$$\begin{matrix}f ( p ) = {( Xp - j )}^{T} ( Xp - j ) \\ where \\ X = [ \begin{matrix}{( {q}_{1} - \overline{q} )}^{T} \\ {( {q}_{2} - \overline{q} )}^{T} \\ {( {q}_{3} - \overline{q} )}^{T} \\ … \\ {( {q}_{N} - \overline{q} )}^{T}\end{matrix} ] \\ j = \frac{1}{2} [ \begin{matrix}{q}_{1}^{T} {q}_{1} - R \\ {q}_{2}^{T} {q}_{2} - R \\ {q}_{3}^{T} {q}_{3} - R \\ … \\ {q}_{N}^{T} {q}_{N} - R\end{matrix} ] \\ \overline{q} = \frac{1}{N} {\sum }_{i = 1}^{N} {q}_{i} \\ R = \frac{1}{N} {\sum }_{i = 1}^{N} {q}_{i}^{T} {q}_{i}\end{matrix}$$

7. A machine readable storage medium for use in a computer, the medium containing a magnetic data processing program which is executable by the computer to perform a process of:
repeatedly accumulating a predetermined number of magnetic data q₁, . . . , q_{N} (N≧4) to provide a statistical population, the predetermined number being four or greater, while sequentially acquiring magnetic data output from a three-dimensional (3D) magnetic sensor;
deriving, each time a statistical population is provided, a minimum value of f(p) as a reliability index S of the statistical population, and determining whether or not the statistical population is sufficiently reliable using the reliability index S; and
deriving an offset of the magnetic data based on the statistical population in case that the statistical population is sufficiently reliable,
wherein f(p) is defined by the following equation:
$$\begin{matrix}f ( p ) = {( Xp - j )}^{T} ( Xp - j ) \\ where \\ X = [ \begin{matrix}{( {q}_{1} - \overline{q} )}^{T} \\ {( {q}_{2} - \overline{q} )}^{T} \\ {( {q}_{3} - \overline{q} )}^{T} \\ … \\ {( {q}_{N} - \overline{q} )}^{T}\end{matrix} ] \\ j = \frac{1}{2} [ \begin{matrix}{q}_{1}^{T} {q}_{1} - R \\ {q}_{2}^{T} {q}_{2} - R \\ {q}_{3}^{T} {q}_{3} - R \\ … \\ {q}_{N}^{T} {q}_{N} - R\end{matrix} ] \\ \overline{q} = \frac{1}{N} {\sum }_{i = 1}^{N} {q}_{i} \\ R = \frac{1}{N} {\sum }_{i = 1}^{N} {q}_{i}^{T} {q}_{i}\end{matrix}$$
